(19) United States
(12) Patent Application Publication
(10) Pub. No.: US 2008/0010010 A1
(43) Pub. Date: Jan. 10, 2008

(54) Navigation system

(75) Inventor: Jye-Ming Le, Taipei (TW)

Correspondence Address: BIRCH STEWART KOLASCH & BIRCH, PO BOX 747, FALLS CHURCH, VA, 22040-0747, US

(73) Assignee: COMPAL COMMUNICATIONS, INC.

(21) Appl. No.: 11/812,939

(22) Filed: Jun. 22, 2007

(30) Foreign Application Priority Data
Jun. 23, 2006 (JP) 095122837

(51) Int. Cl. G01C 21/30; H04Q 7/20

(52) U.S. Cl. 701/208; 455/457

(57) ABSTRACT

The invention discloses a navigation system comprising a mobile communication apparatus and an agent. The mobile communication apparatus comprises a first receiver, a first processor, an input device, a first communication device, and a display. The agent comprises a storage device, a second communication device, and a second processor. The mobile communication apparatus transmits current location information and destination information to the agent. The agent processes the received destination information, the received current location information, and map information transmitted from the storage device to generate a path from the current location to the destination. According to the path, the agent generates navigation information and transmits the navigation information to the mobile communication apparatus to display the navigation information.

### BACKGROUND OF THE INVENTION

1. Field of the Invention

The invention relates to a navigation system and, more particularly, to a navigation system utilizing an agent to process navigation information, and then the navigation information can be displayed on a mobile communication apparatus.

2. Description of the Prior Art

Recently, a global positioning system (GPS) has been applied to various applications. GPS has been integrated into more and more mobile communication apparatuses, such as a navigation device, a smart phone, a personal digital assistance (PDA), and so on.

The mobile communication apparatus with GPS usually has the same framework of software. In general, a navigation system consists of a human-machine interface, a navigation engine, a graphics database. The human-machine interface mainly provides map display, target setting and search, navigation information display, and other related data display for a user. The navigation engine mainly provides functions of planning a path for the movement of a vehicle, calculating velocity, calculating direction, and calculating distance. The graphics database provides information of map and path.

However, since the human-machine interface, the navigation engine, and the graphics database are integrated into a platform, the mobile communication apparatus has to be equipped with a processor capable of processing complicated operation and a memory with large capacity. Accordingly, the mobile communication apparatus with GPS is expensive and not popular.

Therefore, the scope of the invention is to provide a navigation system for providing navigation information for the user. More particularly, according to the navigation system of the invention, the user will not need to equip the mobile communication apparatus with the processor capable of processing complicated operation and the memory with large capacity any more. The mobile communication apparatus can obtain the desired navigation information by cooperating with an agent.

### SUMMARY OF THE INVENTION

A scope of the invention is to provide a navigation system comprising a mobile communication apparatus and an agent. The mobile communication apparatus does not be equipped with a processor capable of processing complicated operation and a memory with large capacity. The mobile communication apparatus can obtain navigation information associated with a destination by cooperating with the agent.

According to a preferred embodiment of the invention, the navigation system comprises a mobile communication apparatus and an agent. The mobile communication apparatus comprises a first receiver, a first processor, an input device, a first communication device, and a display. The first receiver is used for receiving GPS signals broadcasted from at least one satellite. The first processor is electrically connected to the first receiver and used for processing the received GPS signals to obtain a current location information of a current location associated with the mobile communication apparatus. The input device is electrically connected to the first processor and used for a user to input destination information of a destination to the first processor. The first communication device is electrically connected to the first processor and used for transmitting the current location information and the destination information. The display is electrically connected to the first processor and used for displaying information outputted from the first processor

The agent comprises a storage device, a second communication device, and a second processor. The storage device is used for storing a map database. The second communication device is used for receiving the current location information and the destination information transmitted from the mobile communication apparatus. The second processor is electrically connected to the second communication device and the storage device respectively. The second processor is used for processing the received destination information, the received current location information, and map information transmitted from the map database to generate a path from the current location to the destination. According to the path, the second processor generates navigation information associated with a distance between the current location and a middle site on the path. Afterward, the second processor transmits the navigation information to the first communication device, and the navigation information is to be displayed on the display.

The advantage and spirit of the invention may be understood by the following recitations together with the appended drawings.

### BRIEF DESCRIPTION OF THE APPENDED DRAWINGS

FIG. 1 is a schematic diagram illustrating a navigation system according to a preferred embodiment of the invention.

FIG. 2 is a functional block diagram illustrating necessary elements of the navigation system shown in FIG. 1, and FIG. 2 illustrates operation between the mobile communication apparatus and the agent.

### DETAILED DESCRIPTION OF THE INVENTION

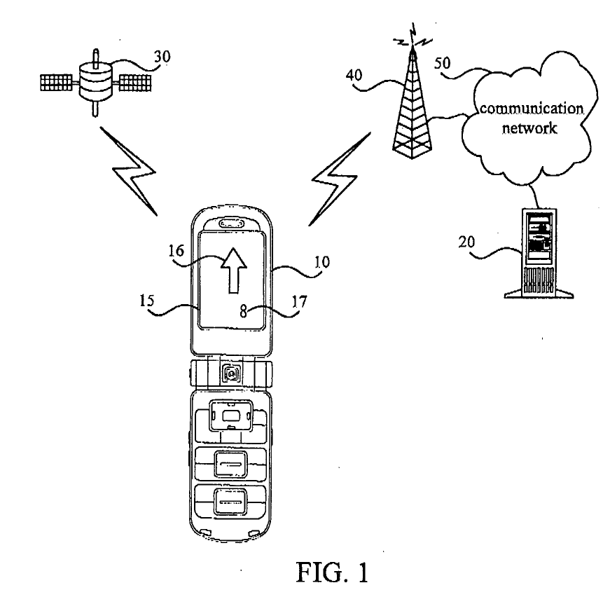

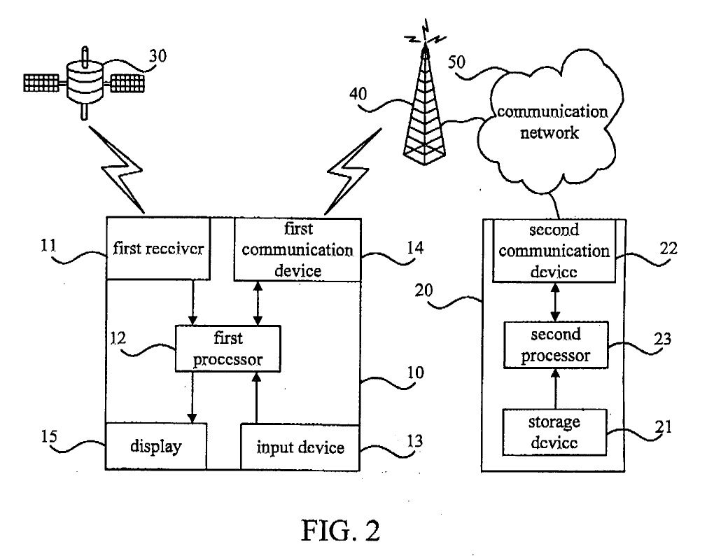

Please refer to FIG. 1 and FIG. 2. FIG. 1 is a schematic diagram illustrating a navigation system according to a preferred embodiment of the invention. FIG. 2 is a functional block diagram illustrating necessary elements of the navigation system shown in FIG. 1. Furthermore, FIG. 2 illustrates operation between the mobile communication apparatus 10 and the agent 20.

As shown in. FIG. 1 and FIG. 2, the navigation system of the invention comprises a mobile communication apparatus 10 and an agent 20. In FIG. 1 and FIG. 2, the mobile communication apparatus 10 is, but not limited to, a mobile phone, and the agent 20 is, but not limited to, a server. The agent 20 is capable of communicating with the mobile communication apparatus 10 via a communication network 50 and a base station 40.

In an embodiment, the mobile communication apparatus 20 complies with a General Packet Radio Service (GPRS) standard.

In an embodiment, the agent 20 is a server installed in a base station.

The mobile communication apparatus 10 comprises a first receiver 11, a first processor 12, an input device 13, a first communication device 14, and a display 15.

The first receiver 11 is used for receiving OPS signals broadcasted from at least one satellite 30. FIG. 1 or FIG. 2 only shows a satellite 30 for representation.

The first processor 12 is electrically connected to the first receiver and used for processing the received GPS signals to obtain current location information of a current location associated with the mobile communication apparatus 10.

The input device 13 is electrically connected to the first processor 12 and used for a user to input destination information of a destination to the first processor 12.

The first communication device 14 is electrically connected to the first processor 12 and used for transmitting the current location information and the destination information.

The display 15 is electrically connected to the first processor 12 and used for displaying information outputted from the first processor 12.

The agent 20 comprises a storage device 21, a second communication device 22, and a second processor 23.

The storage device 21 is used for storing a map database.

The second communication device 22 is used for receiving the current location information and the destination information transmitted from the mobile communication apparatus 10.

The second processor 23 is electrically connected to the second communication device 22 and the storage device 21 respectively. The second processor 23 is used for processing the received destination information, the received current location information, and map information transmitted from the map database to generate a path from the current location to the destination. According to the path, the second processor 23 generates navigation information associated with a distance between the current location and a middle site on the path. Afterward, the second processor 23 transmits the navigation information to the first communication device 14, and the navigation information is to be displayed on the display 15.

As shown in FIG. 1, the navigation information displayed on the display 15 comprises an arrow picture for indicating direction of the movement. Furthermore, the navigation information may also comprise a number 17. As shown in FIG. 1, the number “8” represents the distance to next middle site.

In practical application, the user carries a mobile communication apparatus, such as a mobile phone, cooperating with an agent, such as a server.

In the beginning, the user inputs destination information by the input device of the mobile phone.

The first receiver of the mobile phone receives GPS signals and processes the received GPS signals to obtain current location information of a current location associated with the mobile phone.

The first communication device of the mobile phone transmits the current S location information and the destination information.

The second communication device of the server receives the current location information and the destination information transmitted from the mobile phone via a communication network.

The second processor of the server processes the received destination information, the received current location information, and map information transmitted from the map database to generate a path from the current location to the destination.

According to the path, the second processor of the server generates navigation information associated with a distance between the current location and a middle site on the path..

The second processor of the server transmits the navigation information to the mobile phone, and the navigation information, such as the direction and distance to next middle site, is to be displayed on the display of the mobile phone.

When the user moves to the destination based on the navigation information, the mobile phone will transmit the current location information of the mobile phone to the server every time period, such as ten seconds, so as to update the navigation information. Accordingly, the user can reach the destination set in the beginning by navigation information updated constantly.

Obviously, according to the navigation system of the invention, the user can use a mobile communication apparatus cooperating with an agent to obtain navigation information associated with the destination. It is unnecessary for the mobile communication apparatus to install a processor capable of processing complicated operation and a memory with large capacity. Therefore, the user can obtain GPS information without an expensive mobile communication apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A navigation system, comprising:
a mobile communication apparatus, comprising:
a first receiver for receiving GPS signals broadcasted from at least one satellite;
a first processor, electrically connected to the first receiver, for processing the received GPS signals to obtain, current location information of a current location associated with the mobile communication apparatus;
an input device, electrically connected to the first processor, for a user to input destination information of a destination to the first processor;
a first communication device, electrically connected to the first processor, for transmitting the current location information and the destination information; and
a display, electrically connected to the first processor, for displaying information outputted from the first processor; and
an agent, comprising:
a storage device for storing a map database;
a second communication device for receiving the current location information and the destination information transmitted from the mobile communication apparatus; and
a second processor, electrically connected to the second communication device and the storage device, respectively, for processing the received destination information, the received current location information, and map information transmitted from the map database to generate a path, from the current location to the destination, according to the path, wherein the second processor generates navigation information associated with a distance between the current location and a middle site on the path, and the second processor transmits the navigation information to the first communication device, and wherein, the navigation information is to be displayed on the display.

2. The navigation system of claim 1, wherein the mobile communication apparatus complies with a General Packet Radio Service (GPRS) standard.

3. The navigation system of claim 1, wherein the agent is a server installed in a base station.

4. The navigation system of claim 1, wherein the agent is a server capable of communicating with the mobile communication apparatus via a communication network and a base station.

5. The navigation system of claim 1, wherein the navigation information displayed on the display comprises an arrow picture.
